(19) United States
(12) Patent Application Publication
(10) Pub. No.: US 2026/0172302 A1
(43) Pub. Date: Jun. 18, 2026

(54) ROOT CAUSE IDENTIFICATION OF NETWORK AND POWER OUTAGES

(71) Applicant: Charter Communications Operating, LLC, St. Louis, MO (US)

(72) Inventors: Michael Brian Detty, Lafayette, CO (US); Michael Brandon Mulh, Centennial, CO (US); Taren Geddes McCullough, Plymouth, MN (US)

(21) Appl. No.: 18/984,466

(22) Filed: Dec. 17, 2024

(51) Int. Cl. H04L 41/0631; H04L 41/12

(52) U.S. Cl. CPC H04L 41/065; H04L 41/12

(57) ABSTRACT

A plurality of error indications from a corresponding plurality of customer premises equipment (CPE) communicatively coupled to a same service provider network are obtained, each error indication indicating that an event including a power loss event and/or a network loss event has occurred, each CPE being connected to a corresponding local area network (LAN) and connected to the service provider network via a first transceiver that utilizes a first medium to connect to the service provider network, each error indication being communicated by the plurality of CPE via a second transceiver that utilizes a second medium that is different from the first medium. Topology information that identifies an infrastructure topology is accessed. Based at least in part on the plurality of error indications and the topology information, a particular facility is determined to be a cause of the event, information indicative of the particular facility is sent to a destination.

### BACKGROUND

When a customer premises equipment, such as a gateway router, loses power or network connectivity, a customer may call the service provider to troubleshoot and resolve the issue. The amount of time it takes to resolve the issue may directly impact customer satisfaction.

### SUMMARY

The examples disclosed herein implement root cause identification of network and power outages.

In one implementation a method is provided. The method includes obtaining a plurality of error indications from a corresponding first plurality of customer premises equipment (CPE) communicatively coupled to a same service provider network, each error indication indicating that an event comprising a power loss event and/or a network loss event has occurred, each CPE of the first plurality of CPE being connected to a corresponding local area network (LAN) and connected to the service provider network via a first transceiver that utilizes a first medium to connect to the service provider network, each error indication being communicated by the first plurality of CPE via a second transceiver that utilizes a second medium that is different from the first medium. The method further includes accessing, by the computing device, topology information that identifies an infrastructure topology of a plurality of facilities associated with the event. The method further includes determining, by the computing device, based at least in part on the plurality of error indications and the topology information, a particular facility of the plurality of facilities that is a cause of the event. The method further includes sending, to a destination, information indicative of the particular facility.

In another implementation a computing device is provided. The computing device includes a memory, and a processor device coupled to the memory. The processor device is operable to obtain a plurality of error indications from a corresponding first plurality of customer premises equipment (CPE) communicatively coupled to a same service provider network, each error indication indicating that an event comprising a power loss event and/or a network loss event has occurred, each CPE of the first plurality of CPE being connected to a corresponding local area network (LAN) and connected to the service provider network via a first transceiver that utilizes a first medium to connect to the service provider network, each error indication being communicated by the first plurality of CPE via a second transceiver that utilizes a second medium that is different from the first medium. The processor device is further operable to access topology information that identifies an infrastructure topology of a plurality of facilities associated with the event. The processor device is further operable to determine, based at least in part on the plurality of error indications and the topology information, a particular facility of the plurality of facilities that is a cause of the event. The processor device is further operable to send, to a destination, information indicative of the particular facility.

In another implementation a non-transitory computer-readable storage medium is provided. The non-transitory computer-readable storage medium includes executable instructions operable to cause a processor device to

obtain a plurality of error indications from a corresponding first plurality of customer premises equipment (CPE) communicatively coupled to a same service provider network, each error indication indicating that an event comprising a power loss event and/or a network loss event has occurred, each CPE of the first plurality of CPE being connected to a corresponding local area network (LAN) and connected to the service provider network via a first transceiver that utilizes a first medium to connect to the service provider network, each error indication being communicated by the first plurality of CPE via a second transceiver that utilizes a second medium that is different from the first medium. The instructions are further operable to cause the processor device to access topology information that identifies an infrastructure topology of a plurality of facilities associated with the event. The instructions are further operable to cause the processor device to determine, based at least in part on the plurality of error indications and the topology information, a particular facility of the plurality of facilities that is a cause of the event. The instructions are further operable to cause the processor device to send, to a destination, information indicative of the particular facility.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which root cause identification of network and power outages can be implemented according to some examples;

FIG. 2 is a flowchart of a method for root cause identification of network and power outages according to some implementations;

FIG. 3 is a block diagram of the environment illustrated in FIG. 1 wherein a power loss event has occurred according to one example;

FIG. 4 is a block diagram of the environment illustrated in FIG. 1 wherein a power loss event has occurred according to another example;

FIG. 5 is a block diagram of the environment illustrated in FIG. 1 wherein a network loss event has occurred according to one example;

FIG. 6 is a block diagram of the environment illustrated in FIG. 1 wherein a power loss event has occurred according to another example;

FIG. 7 is a block diagram of the environment illustrated in FIG. 1 wherein a network loss event has occurred according to another example; and

FIG. 8 is a block diagram of a computing device suitable for implementing examples according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A large service provider may provide data communication services, such as Internet access, to millions of customers. To provide such services, the service provider may operate thousands or tens of thousands of network facilities spread over a large geographic area. The devices may be arranged in a tiered structure such as a national data center which may communicate with multiple regional data centers, each regional data center may communicate with multiple hub data centers, each hub data center may communicate with multiple access node data centers, and each access node data center may communicate with multiple CPE located in customer premises, such as home or businesses.

A CPE, such as a wireless gateway router, may implement a local area network (LAN) in a customer premises. The wireless gateway router may also implement layer 3 connectivity, such as internet protocol (IP) connectivity, so that devices on the LAN can communicate with devices on other networks, such as the Internet. The CPE may communicate with the service provider network via another CPE, such as a cable modem, a fiber modem, or the like that is typically located in proximity to the CPE. Some CPE combine the functionality of a wireless gateway router, a cable modem, and an access point in a single device.

If a CPE loses power the CPE cannot report the loss of power to the service provider network because the CPE will be without power. If the CPE loses upstream network connectivity with the service provider network the CPE cannot report the loss of network connectivity because the CPE has no connectivity to the service provider network.

CPE, such as wireless gateway routers, are increasingly being developed with additional transceivers that allow the CPE to communicate with a second network that is a different network than the service provider network via which Internet access is provided. For example, such CPE may be developed with a first transceiver that is operable to communicate with the service provider network via Ethernet, a coaxial cable or a fiber cable, and a second transceiver that is operable to communicate with, for example, a satellite network, a point-to-point microwave network a DSL network, or a cellular network. CPE are also increasingly being developed with battery backups that allow the CPE to continue to operate, at least for a period of time, after losing electrical grid power.

The examples disclosed herein implement root cause identification of network and power outages. A computing device obtains a plurality of error indications from a corresponding plurality of CPE that are communicatively coupled to the same service provider network. Each error indication indicates an event comprising a power loss event and/or a network loss event has occurred. The computing device accesses topology information that identifies an infrastructure topology of facilities associated with the event. The computing device determines, based at least in part on the plurality of error indications and the topology information, a particular facility that is the cause of the event and sends, to a destination, information indicative of the particular facility, such as the address of the facility, an identifier of the facility, or any other information from which the particular facility can be identified.

The computing device can rapidly analyze the error indications, locations of CPE, and the infrastructure topology and identify a root cause of a problem eliminating a need for the computing device, or other computing devices, to iteratively probe CPE or other equipment to determine a status of such CPE or other equipment, and thus processing power that would otherwise be necessary to probe equipment to determine a root cause of the event is greatly reduced.

The examples disclosed herein reduce outage durations because a power loss event or a network loss event can be reported substantially in real-time, and the root cause location of the event can be automatically and rapidly determined, eliminating the need for operators or technicians to manually probe various equipment to determine their status. The examples disclosed herein reduce support calls from customers, and increase customer satisfaction.

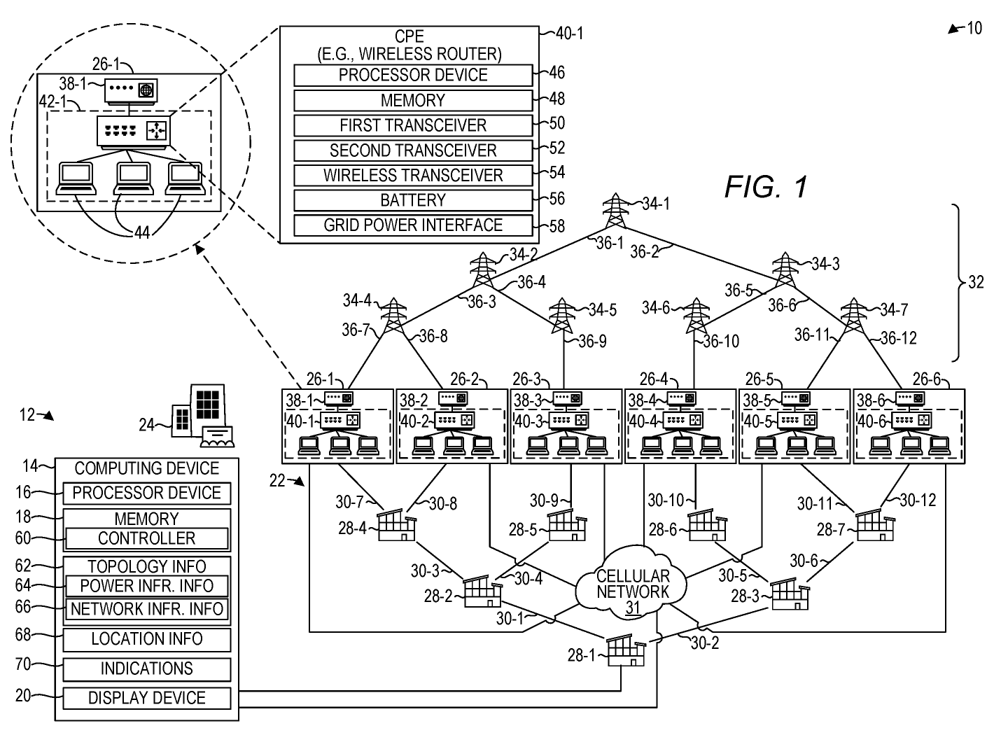

FIG. 1 is a block diagram of an environment 10 in which root cause identification of network and power outages can be implemented according to some examples. The environment 10 includes a system 12 that includes one or more computing devices 14. The computing device 14 includes one or more processor devices 16, a memory 18 and a display device 20. The computing device 14 is communicatively coupled to, or part of, a service provider network 22. The service provider network 22 is operated by a service provider 24 that provides data access, such as Internet access, to a plurality of locations 26-1 – 26-6 (generally, locations 26), each of which is associated with a subscriber.

The service provider network 22 provides service to the locations 26 via network system facilities 28-1 – 28-7 (generally, facilities 28) that communicate via data communication paths 30-1 – 30-12 (generally, data communication paths 30). The facilities 28 may house any number of physical devices, such as switches, routers, fiber nodes, cable modem termination systems, and the like that are physically located at a same network system facility. The communication paths 30 may comprise, by way of non-limiting example, fiber optic cables, coaxial cables, satellite links, point-to-point wireless links, or any combination thereof. As illustrated, the facilities 28 are typically arranged in a tiered network in order to efficiently service what, in practice, may be millions or tens of millions of locations 26 spread over a large geographic area, such as that of the United States. An equipment or communication path outage may prevent Internet access to widely varying numbers of locations 26 depending on where in the service provider network 22 the outage occurs. While only three tiers of network system facilities 28 are illustrated for purposes of simplicity, in practice there may be a larger number of tiers, such as national data center facilities, regional data center facilities, hub data center facilities, and access node facilities which are geographically closest to the locations 26. The locations 26-1 include one or more CPE that are operable to communicate with both the service provider network 22 and a second network, in this example one or more cellular networks 31.

The locations 26 receive power through a power grid 32 that includes a plurality of power distribution system facilities 34-1 – 34-7 (generally, power distribution system facilities 34) and a plurality of power distribution paths 36-1 – 36-12 (generally, power distribution paths 36). The power distribution system facilities 34 contain power distribution devices and equipment. The term “facility” as used here refers to a location at which equipment, such as one or more devices, implement functionality necessary to provide the relevant service to a customer premises. In the context of the service provider network 22 the network service facilities 28 include the necessary equipment to provide broadband or other types of communication services to the locations 26. In the context of the power grid 32 the power distribution system facilities 34 include the necessary equipment to provide electrical power to the locations 26.

The location 26-1 includes a CPE 38-1 which may be a modem, such as a cable modem or fiber modem, that is operable to communicate with the network system facility 28-4, such as a cable modem termination system or fiber node, via the communication path 30-7. The CPE 38-1 may be communicatively coupled to a CPE 40-1 which is connected to and may implement a local area network (LAN) 42-1. The CPE 40-1 may comprise, for example, a wireless gateway router that implements layer 3 connectivity, such as internet protocol (IP) connectivity, so that devices 44 on the LAN 42-1 can communicate with devices on other networks, such as web servers on the Internet. The term “wireless gateway router” as used herein refers to a gateway router that is also a wireless access point, such as a Wi-Fi® access point.

The CPE 40-1 may include a processor device 46, a memory 48, and a first transceiver 50 operable to connect to the CPE 38-1. The first transceiver 50 may comprise, for example, an Ethernet transceiver. In some implementations the functionality of the CPE 38 and the CPE 40 may be combined in a single device, such as a combination cable modem and wireless gateway router or combination fiber modem and wireless gateway router, in which case the first transceiver 50 may comprise a coaxial cable transceiver or a fiber transceiver, respectively.

The CPE 40-1 may also include a second transceiver 52 operable to connect to a second network, such as a satellite network, a point-to-point microwave network a DSL network, or, as illustrated in the Figures, a cellular network 31. The CPE 40-1 may also include a wireless transceiver 54 operable communicate with wireless devices 44. The CPE 40-1 may also include a battery 56, and a grid power interface 58 that is operable to connect to the power grid 32. The grid power interface 58 may include a standard plug that can be inserted into an electrical outlet at the location 26-1 to draw power from the power distribution system facility 34-4.

The locations 26-2 – 26-6 may be similarly configured as described above with regard to the location 26-1. In particular, the locations 26-2 – 26-6 may include CPE 38-2 – 38-6, respectively, each of which is operable to communicate with a network system facility 28. The locations 26-2 – 26-6 may include CPE 40-2 – 40-6, respectively, each of which may be connected to a corresponding CPE 38, and which may implement a LAN at the respective location 26.

The computing device 14 includes a controller 60 that may implement functionality described herein. The computing device 14 includes topology information 62 that identifies the infrastructure topology of the service provider network 22 and the infrastructure topology of the power grid 32. The topology information 62 includes power infrastructure information 64 that identifies the power distribution system facilities 34 and the power distribution paths 36 between the power distribution system facilities 34. The topology information 62 includes network infrastructure information 66 that identifies the network system facilities 28 and the communication paths 30 between the network system facilities 28. The computing device 14 may include location information 68 that identifies the locations of the locations 26.

With this background an example of root cause identification of network and power outages will be discussed. Assume that the CPE 40-1 determines that network connectivity with the service provider network 22 has been lost. The CPE 40-1 sends, via the cellular network 31 to the computing device 14, an error indication that indicates that the CPE 40-1 is experiencing a network loss event. The controller 60 may store the error indication in an indications data structure 70. The error indication may include physical location information that identifies the physical location 26-1. Alternatively, the error indication may contain a unique identifier that corresponds to and identifies the CPE 40-1. The controller 60 may access the location information 68 which comprises a mapping that maps unique identifiers of the CPE 40 to the physical location 26 of each CPE 40.

Substantially concurrently the CPE 40-2 determines that network connectivity with the service provider network 22 has been lost. The CPE 40-2 sends, via the cellular network 31 to the controller 60, an error indication that indicates that the CPE 40-2 is experiencing a network loss event. The controller 60 does not receive error indications from the CPE 40-3 – 40-6. In some implementations, each CPE 40 may periodically provide indications that provide a current status of network connectivity and grid power connectivity. When such indications indicate that the CPE 40 has network connectivity and grid power connectivity such indications may be referred to as error-free indications. In such implementations the controller 60 may access the indications data structure 70 and determine that the most recent indications received from the CPE 40-3 – 40-6 were error-free indications.

The controller 60 may determine the physical locations 26-1, 26-2 of the CPE 40-1, 40-2, respectively. The controller 60 accesses the network infrastructure information 66 that identifies the infrastructure topology of the network system facilities 28 associated with a network loss event. The controller 60 determines, based at least in part on the plurality of error indications and the network infrastructure information 66, that the network system facility 28-4 is the location of the cause of the network loss event, and sends an alert to the display device 20 that contains information indicative of the network system facility 28-4 as a root cause of a network outage.

As another example, assume that the CPE 40-1 determines that the CPE 40-1 has lost power and has switched to battery backup power provided by the battery 56. The CPE 40-1 sends, via the cellular network 31 to the controller 60, an error indication that indicates that the CPE 40-1 is experiencing a power loss event. Substantially concurrently the CPE 40-2 determines that the CPE 40-2 has lost power and has switched to battery backup power. The CPE 40-2 sends, via the cellular network 31 to the controller 60, an error indication that indicates that the CPE 40-2 is experiencing a power loss event.

The controller 60 does not receive error indications from the CPE 40-3 – 40-6 indicating power loss events. The controller 60 may determine the physical locations 26-1, 26-2 of the CPE 40-1, 40-2, respectively. The controller 60 accesses the power infrastructure information 64 that identifies the power distribution system facilities 34 and the power distribution paths 36 between the power distribution system facilities 34.

The controller 60 determines, based at least in part on the plurality of error indications and the power infrastructure information 64, that the power distribution system facility 34-4 is the location of the cause of the power loss event, and sends an alert to the display device 20 that contains information that identifies the power distribution system facility 34-4 as a root cause of a power outage.

It is noted that, because the controller 60 is a component of the computing device 14, functionality implemented by the controller 60 may be attributed to the computing device 14 generally. Moreover, in examples where the controller 60 comprises software instructions that program the processor device 16 to carry out functionality discussed herein, functionality implemented by the controller 60 may be attributed herein to the processor device 16.

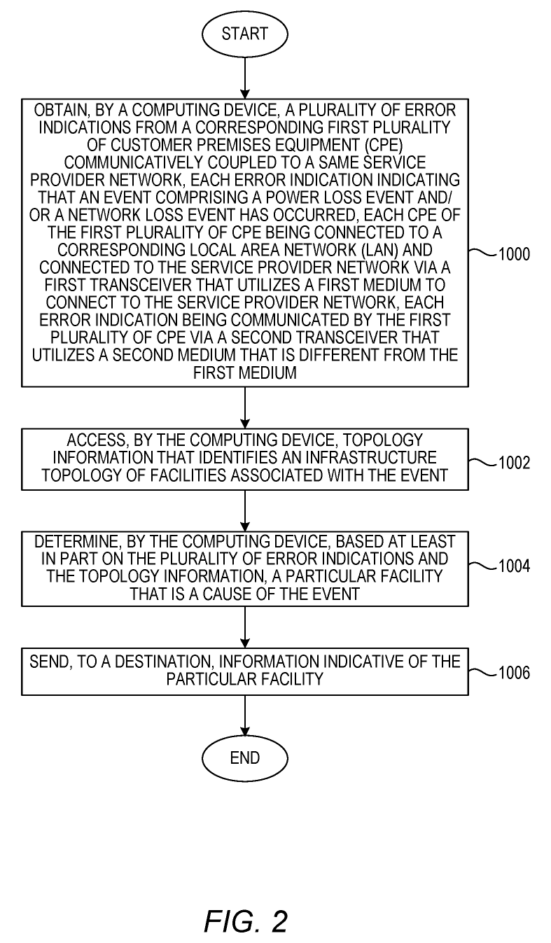

FIG. 2 is a flowchart of a method for root cause identification of network and power outages according to some implementations. FIG. 2 will be discussed in conjunction with FIG. 1. The computing device 14 obtains a plurality of error indications from the plurality of CPE 40-1 and 40-2 that are communicatively coupled to the service provider network 22, each error indication indicating that an event comprising a power loss event and/or a network loss event has occurred, each of the CPE 40-1 and 40-2 being connected to a corresponding LAN and connected to the service provider network via a first transceiver that utilizes a first medium to connect to the service provider network 22, each error indication being communicated by the CPE 40-1 and 40- via a second transceiver that utilizes a second medium that is different from the first medium (FIG. 2, block 1000). The computing device 14 accesses the topology information 62 that identifies an infrastructure topology of facilities associated with the event (FIG. 2, block 1002). The computing device 14 determines, based at least in part on the plurality of error indications and the topology information 62, a particular facility that is a cause of the event (FIG. 2, block 1004). The computing device 14 sends, to a destination, information indicative of the particular facility (FIG. 2, block 1006).

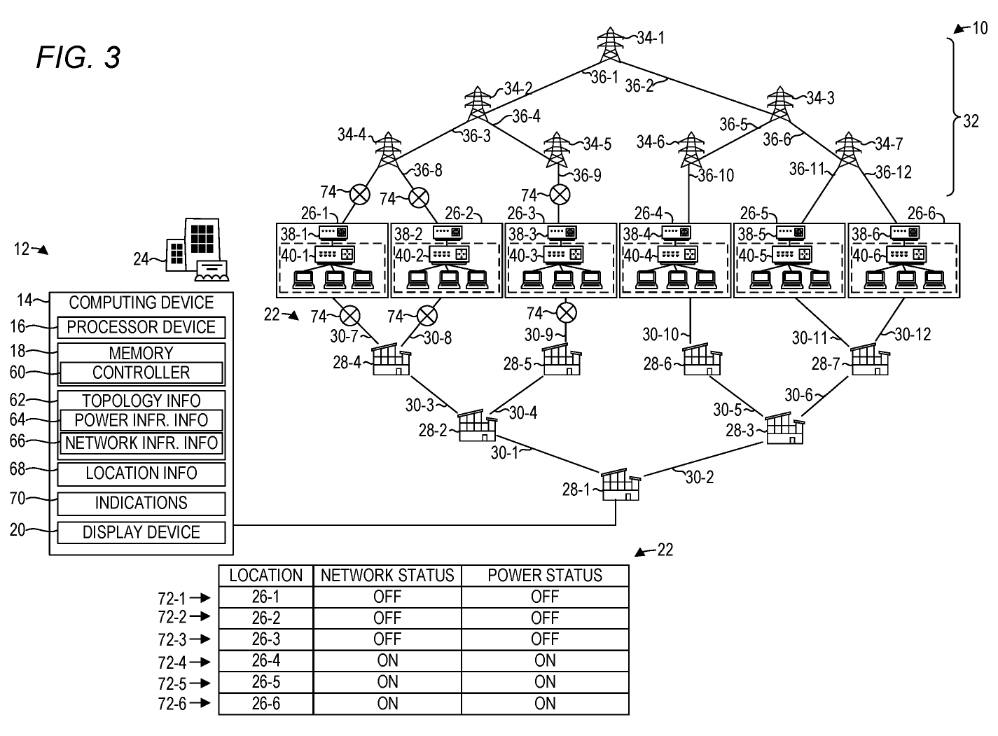

FIG. 3 is a block diagram of the environment 10 illustrated in FIG. 1 wherein a power loss event has occurred according to one example. For spatial and clarity purposes the cellular network 31 has been removed from FIG. 3. The computing device 14 has received a plurality of error indications 72-1 – 72-3 from the CPE 40-1 – 40-3, each of which was sent via the cellular network 31. The computing device 14 has received a plurality of error-free indications 72-4 – 72-6 from the CPE 40-4 – 40-6. The error indications 72-1 – 72-3 each indicate a power loss event and a network loss event, indicated by loss event symbols 74. In this example, the CPE 38 and the CPE 40 are independent devices, and the computing device 14 determines that the network loss event is likely due to the CPEs 38-1 – 38-3 also losing power because without power the CPEs 38-1 – 38-3 cannot provide the CPEs 40-1 – 40-3 with network connectivity.

The computing device 14 accesses the power infrastructure information 64 that identifies the power distribution system facilities 34 and the power distribution paths 36 between the power distribution system facilities 34. In this example, the topology information identifies, for each respective CPE 40, a power distribution path from a power generation power system facility 34-1, through at least one power distribution power system facility 34-2 - 34-7, to a customer premises (e.g., location 26) in which the respective CPE 40 is located.

The computing device 14 determines, based at least in part on the plurality of error indications, the plurality of error-free indications, and the power infrastructure information 64, that the power distribution system facility 34-2 is the location of the cause of the power loss event. In particular, the computing device 14 determines that the CPE 38-3 obtains power from the power distribution system facility 34-5, and that the CPE 38-1 and CPE 38-2 obtain power from the power distribution system facility 34-4, and thus concludes that the root cause is the power distribution system facility 34-2 which provides power to both the power distribution system facilities 34-4 and 34-5. The computing device 14 sends an alert to the display device 20 that contains information indicative of the power distribution system facility 34-2 as a root cause of a power outage.

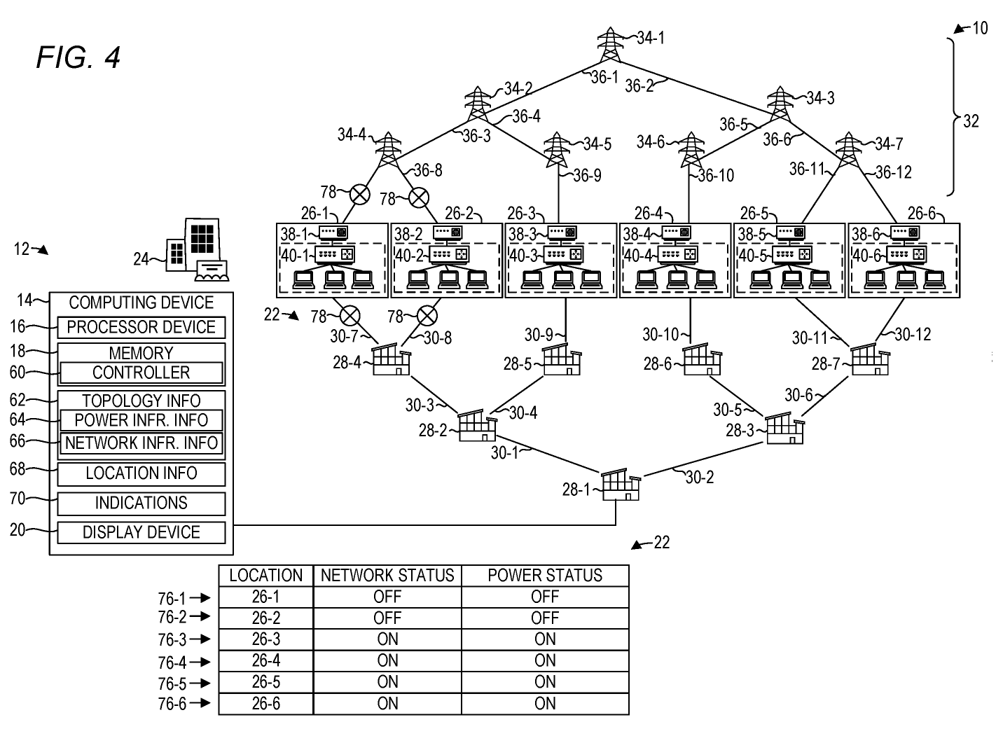

FIG. 4 is a block diagram of the environment 10 illustrated in FIG. 1 wherein a power loss event has occurred according to another example. For spatial and clarity purposes the cellular network 31 has been removed from FIG. 4. The computing device 14 has received a plurality of error indications 76-1 – 76-2 from the CPE 40-1 – 40-2, each of which was sent via the cellular network 31. The computing device 14 has received a plurality of error-free indications 76-3 – 76-6 from the CPE 40-3 – 40-6. The error indications 72-1 – 72-2 each indicate a power loss event and a network loss event, indicated by loss event symbols 78. In this example, the CPE 38 and the CPE 40 are independent devices, and the computing device 14 determines that the network loss event is likely due to the CPEs 38-1 – 38-2 also losing power because without power the CPEs 38-1 – 38-2 cannot provide the CPEs 40-1 – 40-2 with network connectivity.

The computing device 14 accesses the power infrastructure information 64 that identifies the power distribution system facilities 34 and the power distribution paths 36 between the power distribution system facilities 34. The computing device 14 determines, based at least in part on the plurality of error indications, the plurality of error-free indications, and the power infrastructure information 64, that the power distribution system facility 34-4 is the location of the cause of the power loss event. In particular, the computing device 14 determines that the CPE 38-1 and CPE 38-2 obtain power from the power distribution system facility 34-4, and no other CPE 38-3 – 38-6 has indicated a power loss event, and thus concludes that the root cause is the power distribution system facility 34-4. The computing device 14 sends an alert to the display device 20 that contains information indicative of the power distribution system facility 34-4 as a root cause of a power outage.

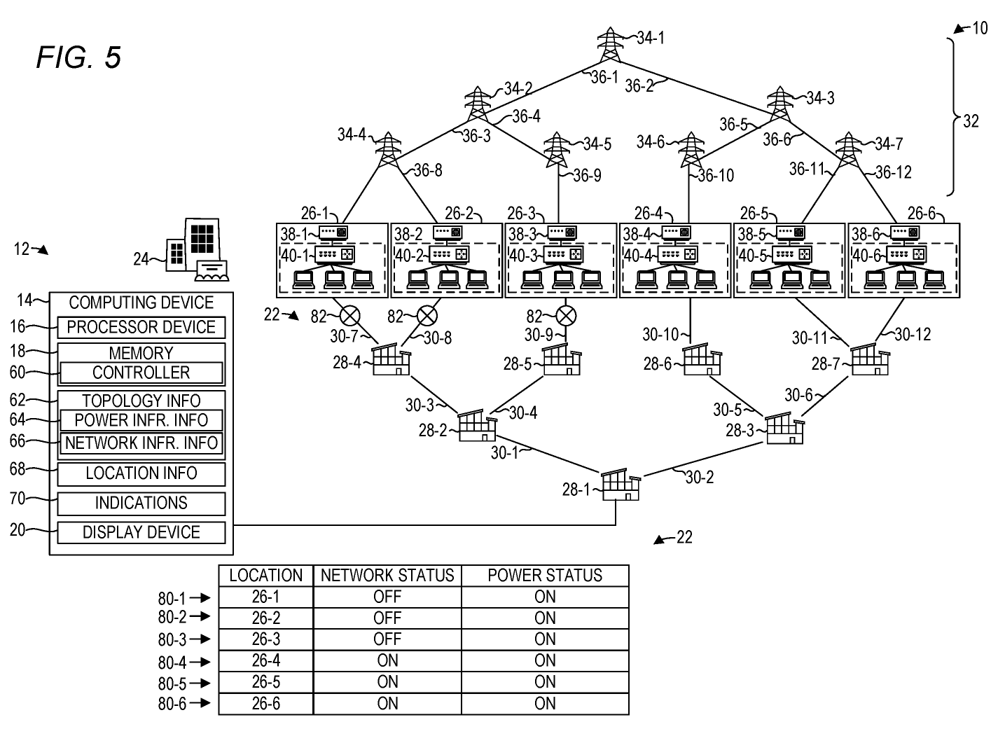

FIG. 5 is a block diagram of the environment 10 illustrated in FIG. 1 wherein a network loss event has occurred according to one example. For spatial and clarity purposes the cellular network 31 has been removed from FIG. 5. The computing device 14 has received a plurality of error indications 80-1 – 80-3 from the CPE 40-1 – 40-3, each of which was sent via the cellular network 31. The computing device 14 has received a plurality of error-free indications 80-4 – 80-6 from the CPE 40-4 – 40-6. The error indications 80-1 – 80-3 each indicate a network loss event, indicated by loss event symbols 82. The computing device 14 accesses the network infrastructure information 66 that identifies the network system facilities 28 and the communication paths 30 between the network system facilities 28. In this example, the topology information identifies a headend network system facility comprising the network system facility 28-1, two regional network facilities comprising, respectively, the network system facilities 28-2, 28-3, and four access node data facilities comprising, respectively, the network system facilities 28-4, 28-5, 28-6, and 28-7.

The computing device 14 determines, based at least in part on the plurality of error indications, the plurality of error-free indications, and the network infrastructure information 66, that the network system facility 28-2 is the location of the cause of the network loss event. In particular, the computing device 14 determines that the CPE 38-3 obtains network connectivity from the network system facility 28-5, and that the CPE 38-1 and CPE 38-2 obtain network connectivity from the network system facility 28-4, and thus concludes that the root cause is the network system facility 28-2 which provides connectivity to both the facilities 28-4 and 28-5. The computing device 14 sends an alert to the display device 20 that contains information that identifies the network system facility 28-2 as a root cause of the network outage. The alert may also indicate the number of locations 26 that are impacted, in this example, three.

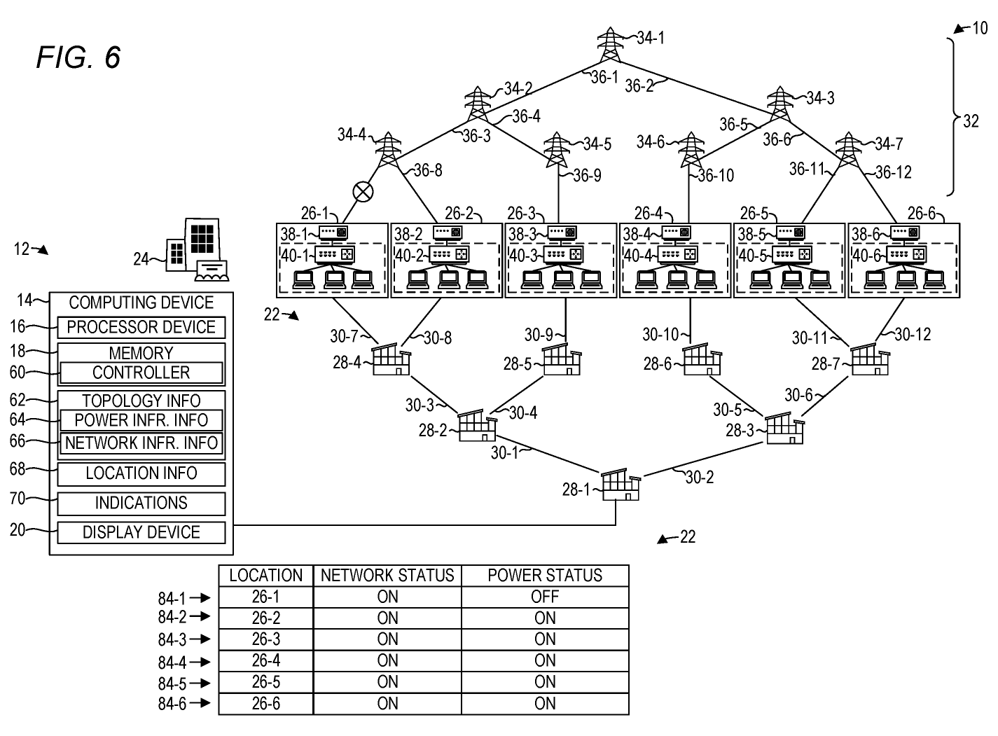

FIG. 6 is a block diagram of the environment 10 illustrated in FIG. 1 wherein a power loss event has occurred according to another example. For spatial and clarity purposes the cellular network 31 has been removed from FIG. 6. The computing device 14 has received an error indication 84-1 from the CPE 40-1 which was sent via the cellular network 31. The computing device 14 has received a plurality of error-free indications 84-2 – 84-6 from the CPE 40-2 – 40-6. The error indication 84-1 indicates a power loss event and that network connectivity exists. Because network connectivity exists, the computing device 14 determines that the CPE 38-1 continues to receive power and thus the power problem is a localized problem, such as may occur if the CPE 40-1 was intentionally or unintentionally unplugged from a wall socket. The computing device 14 may send an alert to the display device 20 that contains information that indicates that the CPE 40-1 has lost grid power but it appears that the CPE 40-1 has been unplugged.

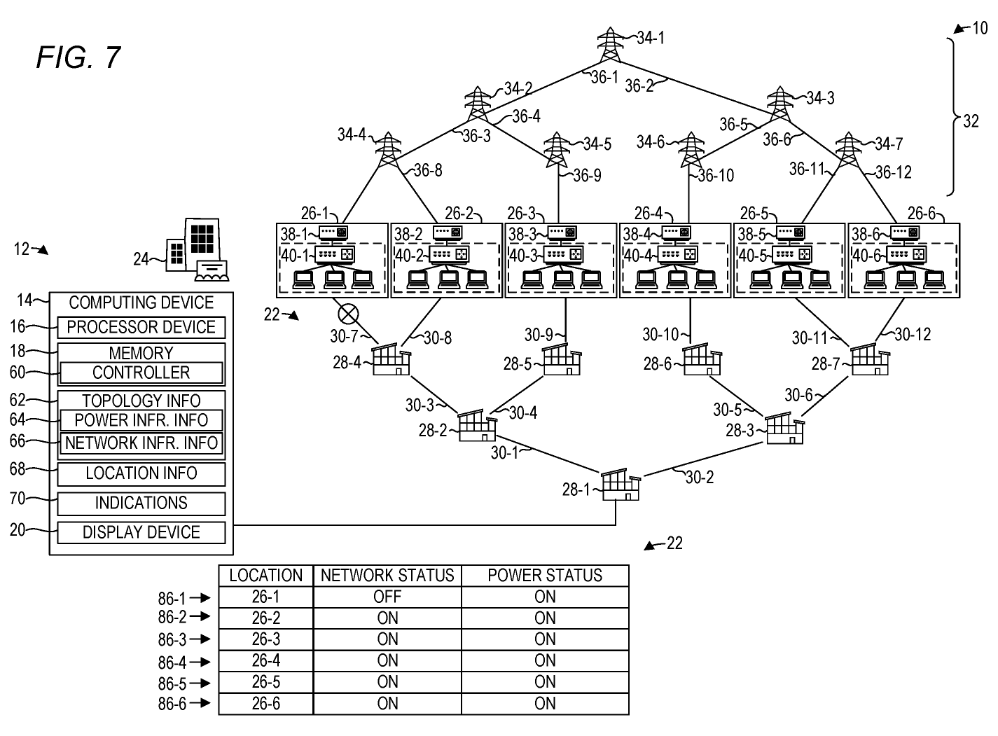

FIG. 7 is a block diagram of the environment 10 illustrated in FIG. 1 wherein a network loss event has occurred according to another example. For spatial and clarity purposes the cellular network 31 has been removed from FIG. 7. The computing device 14 has received an error indication 86-1 from the CPE 40-1 which was sent via the cellular network 31. The error indication 86-1 indicates a network loss event and that power has not been lost. The computing device 14 has received a plurality of error-free indications 86-2 – 86-6 from the CPE 40-2 – 40-6. Because the CPE 40-2 has network connectivity, the computing device 14 determines that the network problem is a localized problem, such as may occur if there is a loose or disconnected wide area network connection between the CPE 40-1 and the CPE 38-1. The computing device 14 may send an alert to the display device 20 that contains information that indicates that the CPE 40-1 has lost network connectivity but it appears to be a localized problem with the CPE 40-1 and the CPE 38-1.

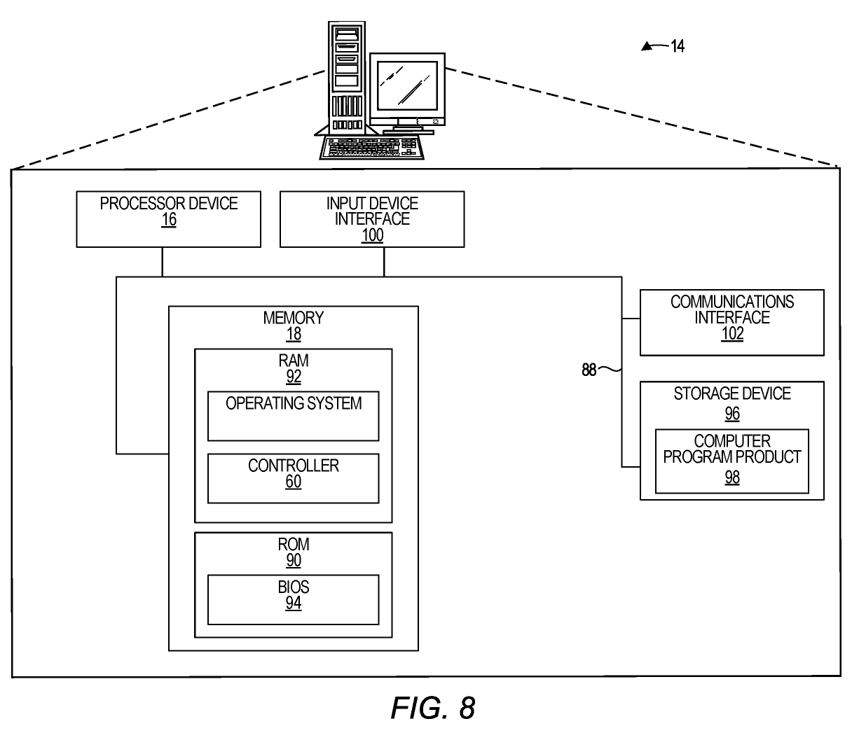

FIG. 8 is a block diagram of the computing device 14 suitable for implementing examples according to one implementation. The computing device 14 may comprise any computing or electronic device capable of including firmware, hardware, and/or executing software instructions to implement the functionality described herein, such as a computer server, a desktop computing device, or the like. The computing device 14 includes the processor device 16, the system memory 18, and a system bus 88. The system bus 88 provides an interface for system components including, but not limited to, the system memory 18 and the processor device 16. The processor device 16 can be any commercially available or proprietary processor.

The system bus 88 may be any of several types of bus structures that may further interconnect to a memory bus (with or without a memory controller), a peripheral bus, and/or a local bus using any of a variety of commercially available bus architectures. The system memory 18 may include non-volatile memory 90 (e.g., read-only memory (ROM), erasable programmable read-only memory (EPROM), electrically erasable programmable read-only memory (EEPROM), etc.), and volatile memory 92 (e.g., random-access memory (RAM)). A basic input/output system (BIOS) 94 may be stored in the non-volatile memory 90 and can include the basic routines that help to transfer information between elements within the computing device 14. The volatile memory 92 may also include a high-speed RAM, such as static RAM, for caching data.

The computing device 14 may further include or be coupled to a non-transitory computer-readable storage medium such as a storage device 96, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 96 and other drives associated with computer-readable media and computer-usable media may provide non-volatile storage of data, data structures, computer-executable instructions, and the like.

A number of modules can be stored in the storage device 96 and in the volatile memory 92, including an operating system and one or more program modules, such as the controller 60, which may implement the functionality described herein in whole or in part. All or a portion of the examples may be implemented as a computer program product 98 stored on a transitory or non-transitory computer-usable or computer-readable storage medium, such as the storage device 96, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the controller 60 in the volatile memory 92, may serve as a controller, or control system, for the computing device 14 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 100 that is coupled to the system bus 88 but can be connected by other interfaces such as a parallel port, an Institute of Electrical and Electronic Engineers (IEEE) 1394 serial port, a Universal Serial Bus (USB) port, an IR interface, and the like. The computing device 14 may also include one or more communications interfaces 102, such as an Ethernet transceiver, a Wi-Fi transceiver, a cellular transceiver or the like.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing device, a plurality of error indications from a corresponding first plurality of customer premises equipment (CPE) communicatively coupled to a same service provider network, each error indication indicating that an event comprising a power loss event and/or a network loss event has occurred, each CPE of the first plurality of CPE being connected to a corresponding local area network (LAN) and connected to the service provider network via a first transceiver that utilizes a first medium to connect to the service provider network, each error indication being communicated by the first plurality of CPE via a second transceiver that utilizes a second medium that is different from the first medium;
accessing, by the computing device, topology information that identifies an infrastructure topology of a plurality of facilities associated with the event;
determining, by the computing device, based at least in part on the plurality of error indications and the topology information, a particular facility of the plurality of facilities that is a cause of the event; and
sending, to a destination, information indicative of the particular facility.

2. The method of claim 1, wherein the plurality of error indications indicates the power loss event, and wherein the topology information identifies an infrastructure topology of a plurality of power distribution facilities and power distribution paths between the plurality of power distribution facilities, and wherein sending the information indicative of the particular facility comprises sending information indicative of a particular power distribution system facility.

3. The method of claim 1, further comprising:
obtaining, by the computing device, a plurality of error-free indications from a corresponding second plurality of CPE communicatively coupled to the service provider network, each error-free indication indicating that a CPE of the second plurality of CPE has power and network connectivity with the service provider network;
wherein the particular facility that is the cause of the event is further determined based at least in part on the plurality of error indications, the topology information, and the plurality of error-free indications.

4. The method of claim 1, wherein the event comprises a network loss event, and wherein the topology information identifies an infrastructure topology of a plurality of network system facilities and communication paths between the network system facilities, and wherein sending the information indicative of the particular facility comprises sending information indicative of a particular network system facility.

5. The method of claim 1, wherein are least one CPE of the first plurality of CPE comprises a gateway router that implements the corresponding LAN and that is connected to the service provider network via a cable modem or a fiber modem.

6. The method of claim 1, wherein the plurality of error indications includes information identifying a physical location of the corresponding CPE.

7. The method of claim 1, wherein each error indication includes a unique identifier that identifies a corresponding CPE, and further comprising:
accessing a mapping that maps unique identifiers of each of the first plurality of CPE to a physical location of each CPE of the first plurality of CPE; and
determining the physical location of each CPE of the first plurality of CPE based on the mapping.

8. The method of claim 1, wherein the plurality of error indications indicates a power loss event, and wherein the topology information identifies, for each respective CPE of the first plurality of CPE, a power distribution path from a power generation facility, through at least one power distribution system facility, to a customer premises in which the respective CPE is located.

9. The method of claim 1, wherein the plurality of error indications indicates the network loss event, and wherein the topology information identifies, for each respective CPE of the first plurality of CPE, a data communications path from a headend network system facility of the service provider network, through at least one regional network system facility, to a customer premises in which the respective CPE is located.

10. A computing device, comprising:
a memory; and
a processor device coupled to the memory operable to:
obtain a plurality of error indications from a corresponding first plurality of customer premises equipment (CPE) communicatively coupled to a same service provider network, each error indication indicating that an event comprising a power loss event and/or a network loss event has occurred, each CPE of the first plurality of CPE being connected to a corresponding local area network (LAN) and connected to the service provider network via a first transceiver that utilizes a first medium to connect to the service provider network, each error indication being communicated by the first plurality of CPE via a second transceiver that utilizes a second medium that is different from the first medium;
access topology information that identifies an infrastructure topology of a plurality of facilities associated with the event;
determine, based at least in part on the plurality of error indications and the topology information, a particular facility of the plurality of facilities that is a cause of the event; and
send, to a destination, information indicative of the particular facility.

11. The computing device of claim 10, wherein the plurality of error indications indicates the power loss event, and wherein the topology information identifies an infrastructure topology of a plurality of power distribution facilities and power distribution paths between the plurality of power distribution facilities, and wherein to send the information indicative of the particular facility, the processor device is further operable to send information indicative of a particular power distribution system facility.

12. The computing device of claim 10, wherein the processor device is further operable to:
obtain a plurality of error-free indications from a corresponding second plurality of CPE communicatively coupled to the service provider network, each error-free indication indicating that a CPE of the second plurality of CPE has power and network connectivity with the service provider network;
wherein the particular facility that is the cause of the event is further determined based at least in part on the plurality of error indications, the topology information, and the plurality of error-free indications.

13. The computing device of claim 10, wherein the event comprises a network loss event, and wherein the topology information identifies an infrastructure topology of a plurality of network system facilities and communication paths between the network system facilities, and wherein to send the information indicative of the particular facility, the processor device is further operable to send information indicative of a particular network system facility.

14. The computing device of claim 10, wherein are least one CPE of the first plurality of CPE comprises a gateway router that implements the corresponding LAN and that is connected to the service provider network via a cable modem or a fiber modem.

15. A non-transitory computer-readable storage medium that includes executable instructions operable to cause a processor device to:
obtain a plurality of error indications from a corresponding first plurality of customer premises equipment (CPE) communicatively coupled to a same service provider network, each error indication indicating that an event comprising a power loss event and/or a network loss event has occurred, each CPE of the first plurality of CPE being connected to a corresponding local area network (LAN) and connected to the service provider network via a first transceiver that utilizes a first medium to connect to the service provider network, each error indication being communicated by the first plurality of CPE via a second transceiver that utilizes a second medium that is different from the first medium;
access topology information that identifies an infrastructure topology of a plurality of facilities associated with the event;
determine, based at least in part on the plurality of error indications and the topology information, a particular facility of the plurality of facilities that is a cause of the event; and
send, to a destination, information indicative of the particular facility.

16. The non-transitory computer-readable storage medium of claim 15, wherein the plurality of error indications indicates the power loss event, and wherein the topology information identifies an infrastructure topology of a plurality of power distribution facilities and power distribution paths between the plurality of power distribution facilities, and wherein to send the information indicative of the particular facility, the instructions further cause the processor device to send information indicative of a particular power distribution system facility.

17. The non-transitory computer-readable storage medium of claim 15, wherein the instructions further cause the processor device to:
obtain a plurality of error-free indications from a corresponding second plurality of CPE communicatively coupled to the service provider network, each error-free indication indicating that a CPE of the second plurality of CPE has power and network connectivity with the service provider network;
wherein the particular facility that is the cause of the event is further determined based at least in part on the plurality of error indications, the topology information, and the plurality of error-free indications.

18. The non-transitory computer-readable storage medium of claim 15, wherein the event comprises a network loss event, and wherein the topology information identifies an infrastructure topology of a plurality of network system facilities and communication paths between the network system facilities, and wherein to send the information indicative of the particular facility, the instructions further cause the processor device to send information indicative of a particular network system facility.

19. The non-transitory computer-readable storage medium of claim 15, wherein are least one CPE of the first plurality of CPE comprises a gateway router that implements the corresponding LAN and that is connected to the service provider network via a cable modem or a fiber modem.

20. The non-transitory computer-readable storage medium of claim 15, wherein the plurality of error indications indicates the network loss event, and wherein the topology information identifies, for each respective CPE of the first plurality of CPE, a data communications path from an originating server in a headend facility of the service provider network, through at least one regional network facility, to a customer premises in which the respective CPE is located.
